(19) United States
(12) Patent Application Publication
(10) Pub. No.: US 2002/0139822 A1
(43) Pub. Date: Oct. 3, 2002

(54) Holster apparatus and method for use with a handheld device

(76) Inventor: James C. Infanti, Waterloo (CA)

Correspondence Address: Shawn A. McClintic, Jones, Day, Reavis & Pogue, North Point, 901 Lakeside Avenue, Cleveland, OH, 44114, US

(21) Appl. No.: 09/824,381

(22) Filed: Apr. 2, 2001

(51) Int. Cl. B65D 25/52; A01K 97/04; A45F 5/00

(52) U.S. Cl. 224/197; 224/269; 224/930

(57) ABSTRACT

An apparatus for use with a handheld device, which includes a holster configured to receive and releasably retain the handheld device. The apparatus also includes a clip assembly. The apparatus further includes a mounting structure centered on an axis configured to secure the clip assembly to the holster. The mounting structure has a hub supporting the clip assembly for rotation relative to the holster about the axis.

### FIELD OF INVENTION

This invention relates to the field of carrying cases, particularly those of the type used to carry small, portable handheld electronic devices.

### BACKGROUND

A standard carrying case or pouch generally includes a clip. Such a clip can attach the case to such things as a belt or over the waistline of clothes. Mobile handhelds, such as the RIM® 957 Wireless Handheld™, are carried in cases having such a clip. The clip is used to attach the case to the user's belt or over the waistline of their clothes, as examples, to make carrying easier.

It is sometimes desirable that the handheld device be securely held in the carrier. The user may perform actions that would cause a handheld device that was not securely held in the carrier to fall from the carrier and potentially be damaged. Also, there are carriers for handheld devices that do not allow easy access to the devices while the devices are in the carrier.

### SUMMARY

The clip assembly of the present invention is particularly useful for cases and pouches that hold, store, and carry handheld electronic devices. Examples of such devices include data communication devices, mobile handhelds, cellular phones, digital wireless phones, 1-way pagers, 1½-way pagers, 2-way pagers, electronic mail appliances, internet appliances, personal digital assistants (PDA), laptop computers, and portable digital audio players.

The present invention provides an apparatus for use with a handheld device, which includes a holster configured to receive and releasably retain the handheld device. The apparatus also includes a clip assembly. The apparatus further includes a mounting structure centered on an axis configured to secure the clip assembly to the holster. The mounting structure has a hub supporting the clip assembly for rotation relative to the holster about the axis. The mounting structure may further have a detent structure defining an array of selectable positions spaced circumferentially about the axis.

Another aspect of the invention provides an apparatus including a handheld device. The apparatus also includes a holster configured to receive and releasably retain the handheld device. The handheld device and the holster together defining interlocking tabs and slots configured to co-operate to releasably retain the handheld device in the holster.

The present invention also provides a method of adjusting the position of a handheld device in a device holster. The method includes the step of providing a holster having a rotatable clip assembly, where the holster is for use with a handheld device. The method also includes the step of placing the handheld device in the holster. The method further includes the step of rotating the clip assembly relative to the holster to a desired position, thereby to adjust the handheld device holster.

### BRIEF DESCRIPTION OF THE DRAWINGS

FIG. 1 is a front view of a first embodiment of the present invention;

FIG. 2 is a front view of an apparatus that is part of the embodiment shown in FIG. 1, the handheld device has been omitted for clarity;

FIG. 3 is a rear view of the apparatus shown in FIG. 2;

FIG. 4 is a side view of the apparatus shown in FIG. 2;

FIG. 5 is a rear view of a part of the apparatus as in FIG. 2, the clip assembly has been omitted for clarity.

FIG. 6 is a front view of a part of the clip assembly shown in FIG. 4.

FIG. 7 is a rear view of the part of the clip assembly shown in FIG. 6.

FIG. 8 is a side view of the part of the clip assembly shown in FIG. 6.

FIG. 9 is a perspective view of the part of the clip assembly shown in FIG. 6.

FIG. 10 is a rear view of a part of the clip assembly shown in FIG. 4.

FIG. 11 is a front view of the part of the clip assembly shown in FIG. 10.

FIG. 12 is a side view of the part of the clip assembly shown in FIG. 10.

FIG. 13 is a perspective view of the part of the clip assembly shown in FIG. I/O.

FIG. 14 is a perspective view of a part of the apparatus shown in FIG. 2.

FIG. 15 is a front view of a second embodiment of the present invention.

FIG. 16 is a rear view of the embodiment of the invention shown in FIG. 15.

FIG. 17 is a first side view of the embodiment of the invention shown in FIG. 15.

FIG. 18 is an opposite side view of the embodiment of the invention shown in FIG. 17.

FIG. 19 is a top view of the embodiment of the invention shown in FIG. 15.

FIG. 20 is a front view of the apparatus shown in FIG. 2 with a portion cut away for clarity.

FIG. 21 is an enlarged view of the cut away section of the apparatus shown in FIG. 15.

FIG. 22 is a block diagram of a preferred mobile communication device, with which the instant invention may be used in conjunction.

### DESCRIPTION OF THE DRAWINGS

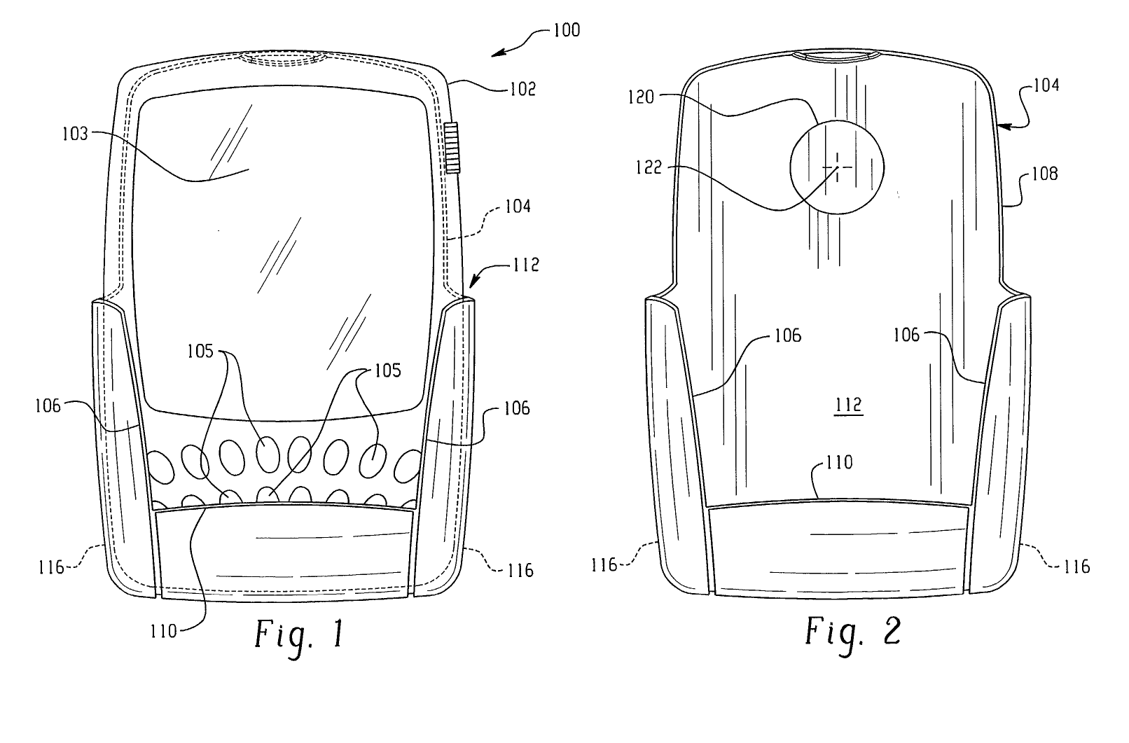

An apparatus 100 comprising a first embodiment of the present invention is shown in FIG. 1. The apparatus 100 includes a handheld electronic device 102 in an installed position in a holster 104.

In the first embodiment of the present invention, the handheld device is a RIM 957 Wireless Handheld™. In another, different embodiment of the present invention, the handheld device is a device as disclosed in co-pending and co-owned U.S. patent application Ser. No. 09/344,432, Hand-held Electronic Device with a Keyboard Optimized for Use with the Thumbs, filed Jun. 25, 1999, which is hereby incorporated by reference. Other examples of handheld devices can include cellular phones, mobile handhelds, digital wireless phones, 1-way pagers, 1½-way pagers, 2-way pagers, electronic mail appliances, internet appliances, personal digital assistants (PDA), laptop computers, portable digital audio players, and the like.

In the first embodiment, the handheld device 102 has a screen 103 and a keypad 105 that face outward from the holster 104. Accordingly, the screen 103 can display visible messages, and the keypad 105 can be accessed, while the handheld device 102 is holstered. Messages can include advertisements, logos, slogans, reminders, and the like.

With reference to FIG. 1, two channel-shaped portions 106 extend along the sides of the holster 104. The channel-shaped portions 106, along with a back wall portion 108 and a front wall portion 110, combine to define a pocket 112. On each channel-shaped portion 106 is a retaining latch 116, symmetrically located relative to each other. Although one retaining latch 116 is shown in each channel portion 106, alternatively there could be more than one latch 116.

FIG. 2 is a front view of the holster 104 of FIG. 1 with the handheld electronic device 102 removed for clarity. A button 120 is centered on an axis 122. The button 120 extends through to the rear of the back wall portion 108 and is described in more detail with reference to FIG. 14, below.

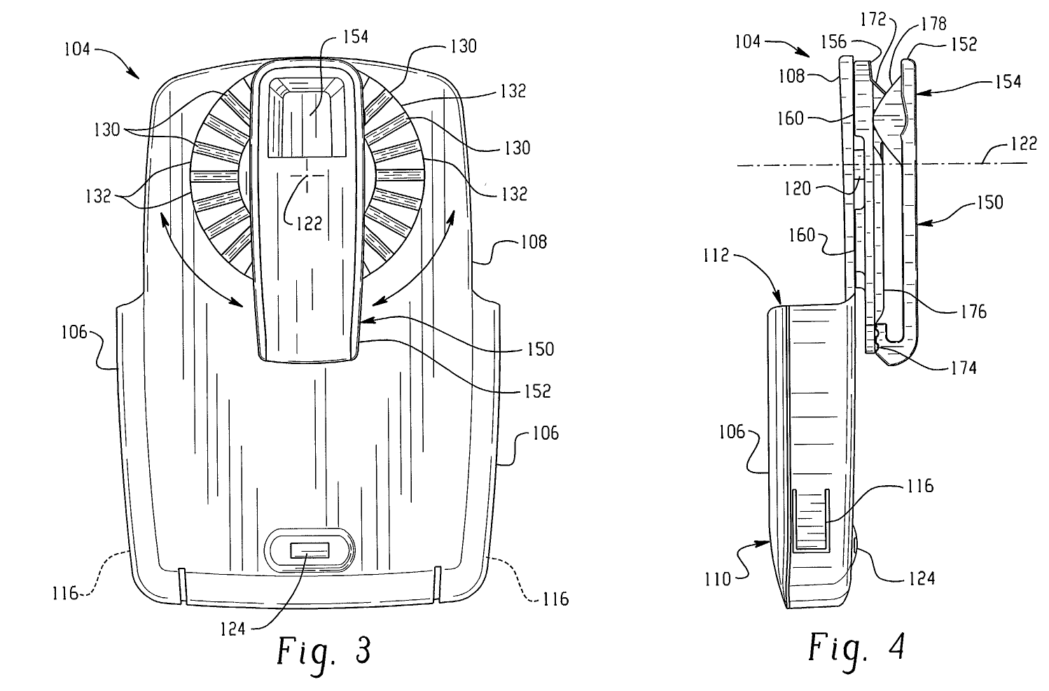

FIG. 3 is a rear view of the holster of FIG. 2. A small magnet 124 is located on the rear of the holster 104. An array of ribs 130 of equal size and shape extend radially outward and define a peripheral boundary centered on the axis 122. Spaced between the ribs 130 are a corresponding plurality of landing surfaces 132. In this embodiment, the landing surfaces 132 are flush with the back of the holster 104. The ribs 130 and the landing structures 132 are parts of a mounting system. Also shown is a swivel clip assembly 150 having a clip top 152. There is a thumb depression 154 at the top end of the outer face of the clip top 152.

With reference to FIG. 4, a side view of the holster 104 is shown. One of the side latches 116 is visible in the side wall portion 106 of the holster 104. The clip assembly 150 is mounted on the rear of the holster 104. The side view of the swivel clip assembly 150 shows the clip top 152 in cooperating engagement with a clip bottom 156.

The clip assembly 150 is spring loaded. The manner of attachment and assembly of the clip top 152 to the clip bottom 156 is described in co-pending and co-owned U.S. Pat. No. 6,073,318, Retaining Clip Assembly, issued Jun. 13, 2000 which is hereby incorporated by reference. With the clip assembly 150, the holster 104 can clip to a belt and over the waistline of clothes, as examples, while retaining and protecting the handheld device 102. A side view of landing structures 160 located on the front, mounting side of the clip bottom 156 is also shown. The landing structures 160 are part of the mounting system.

With reference to FIG. 4, the clip bottom 156 has two hinge bottoms 172, one of which is visible. Toe grips 174 are located at the edge of the clip bottom 156. Ridge grips 176 are perpendicular to the toe grips 174 and run lengthways along the clip bottom 156. The clip top 152 is shown in FIG. 4. The clip top 152 has two hinge tops 178, one of which is visible.

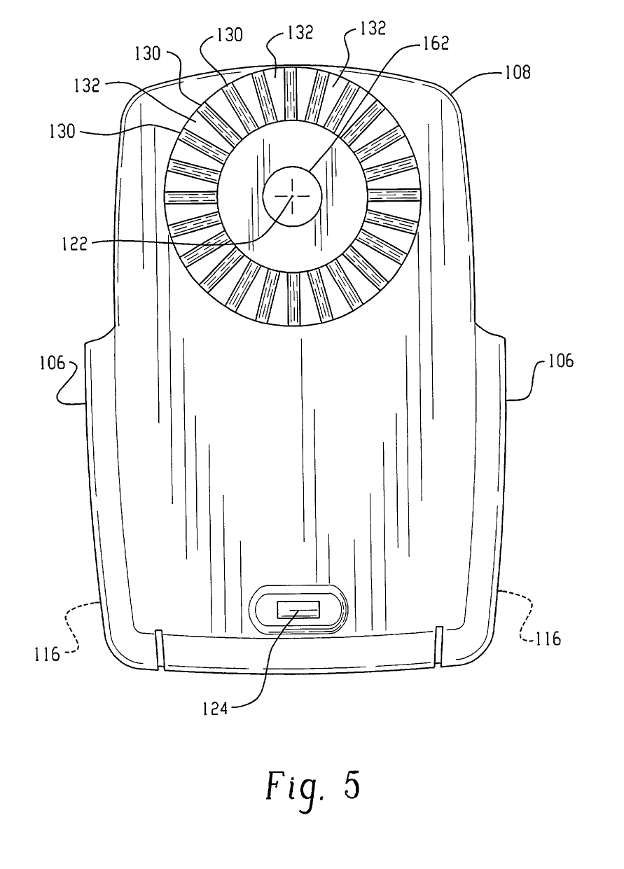

FIG. 5 is a rear view of part of the holster 104 shown in FIG. 3. In particular, the holster 104 of FIG. 3 is shown with the clip assembly 150 removed. An aperture 162 is centered on the axis 122, as shown.

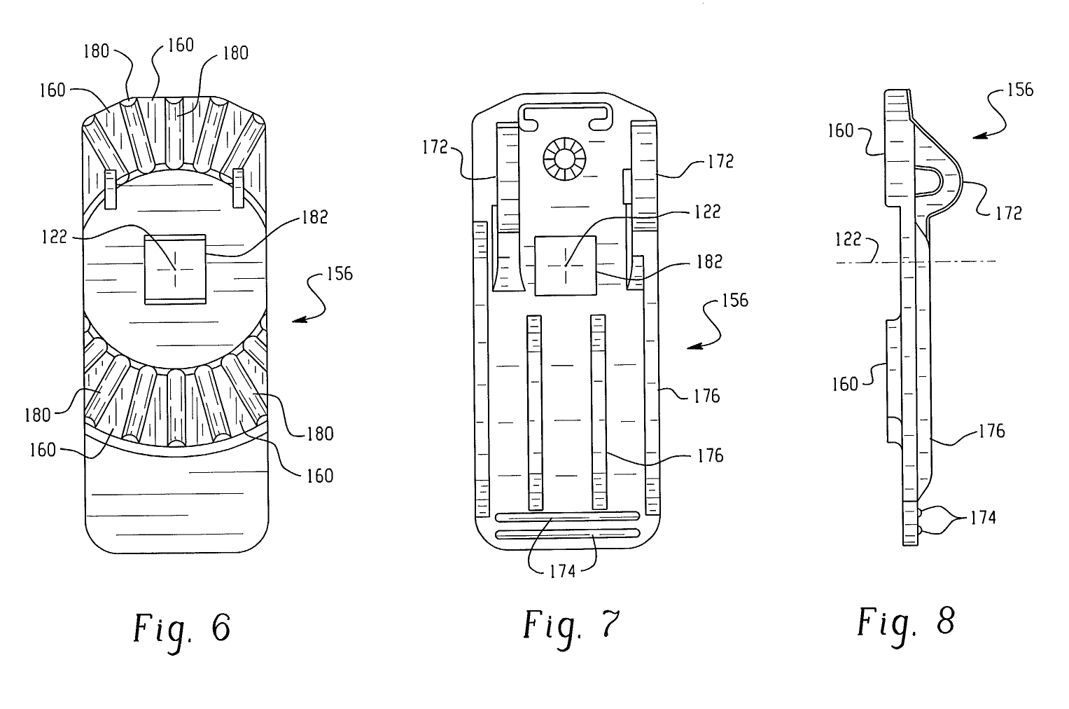

With reference to FIG. 6, a front, mounting side view of the clip bottom 156 is shown. The landing structures 160 are visible, as well as receiving grooves 180. The landing structures 160 are in an array extending radially outward from the axis 122. The receiving grooves 180 are spaced equally between the landing structures 160. A rectangular aperture 182 is centered on the axis 122. The receiving grooves 180 and the landing structures 160 are configured to cooperate with the ribs 130 and the landing structures 132 as parts of the mounting system.

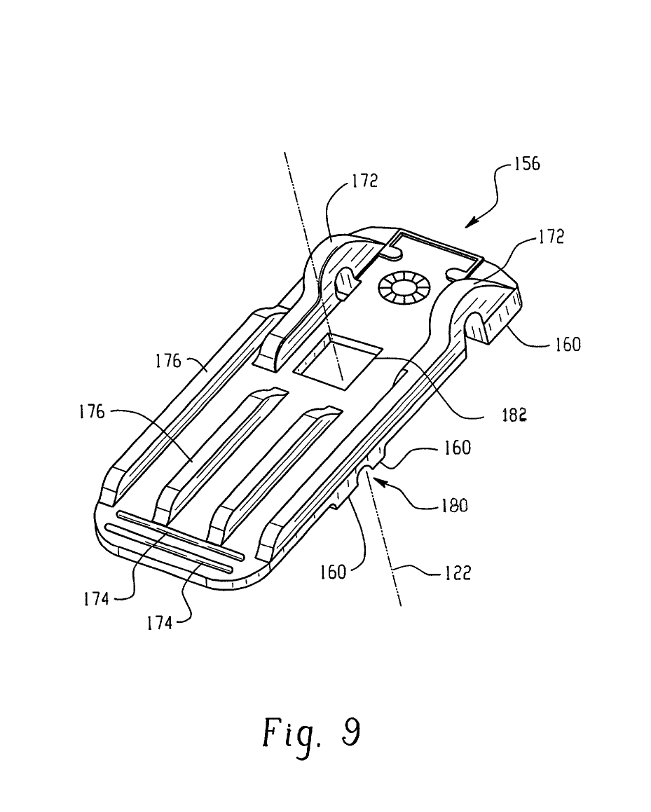

FIG. 7 is a reverse view of the clip bottom 156 shown in FIG. 6. FIG. 8 is a side view of the clip bottom 156 shown in FIGS. 6 and 7. FIG. 9 is a perspective view of the clip bottom 156 shown in FIGS. 6-8.

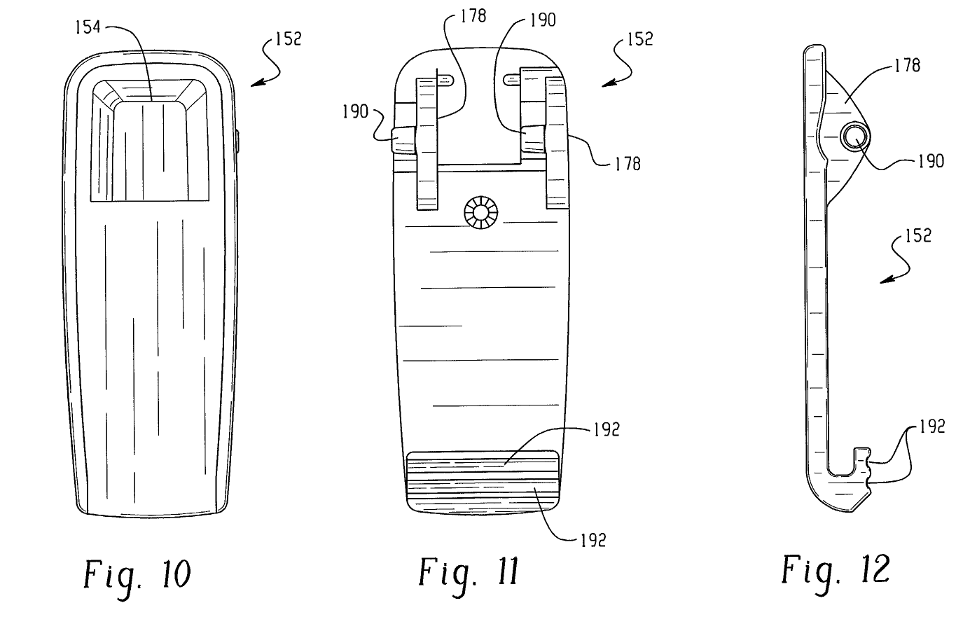

With reference to FIG. 10, a rear view of the clip top 152 is shown. FIG. 11 is a reverse view of the clip top 152 shown in FIG. 10. Each hinge top 178 has a hinge pin 190. The hinge pins 190 face in the same direction relative to each other. Receiving depressions 192 are shown on the toe of the clip top 152.

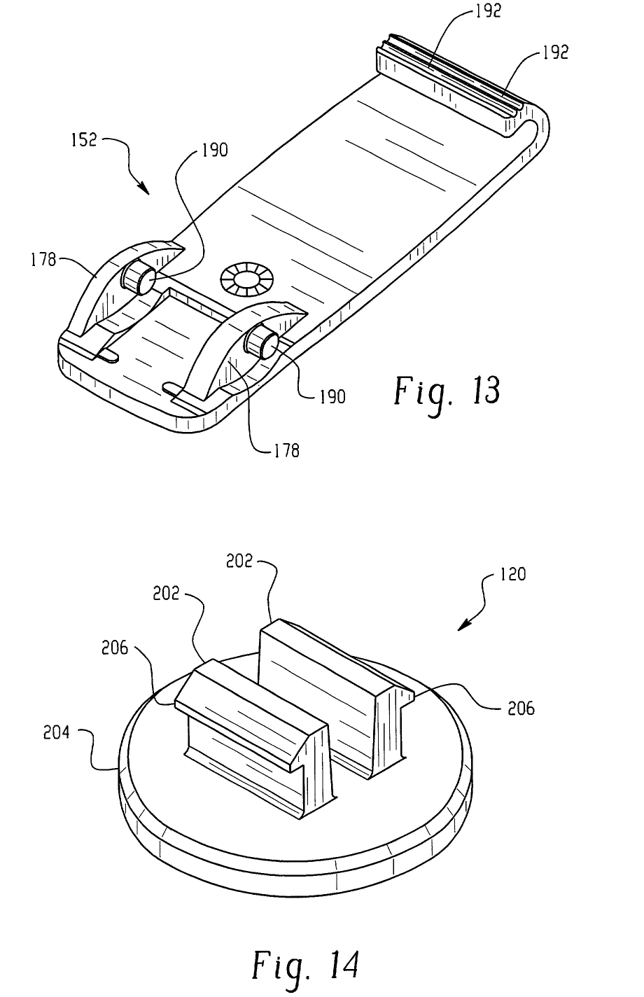

FIG. 12 is a side view of the clip top 152 shown in FIGS. 10 and 11. FIG. 13 is a perspective view of the clip top 152 shown in FIGS. 10-12.

With reference to FIG. 14, the button 120 is shown in a perspective view. The button 120 has a button body 204. Two legs 202 extend in parallel from one side of the button body 204. With the button body 204 at a proximal end of the legs 202, a pair of outwardly opposing tabs 206 are located at the distal ends the legs 202.

When assembled, the clip top 152 is engaged with the clip bottom 154 by the hinge pins 190 and a leaf spring, not shown, as described above. The mounting side of the clip bottom 154 adjoins the rear of the holster body 108 so that the rectangular aperture 182 is centered on the axis 122. The button 120 extends through the aperture 162 from the front. The flange legs 202 of the button 120 further extend through the rectangular aperture 182. The flanges 206 snap-fit the clip assembly 150 to the holster body 108.

The clip top 152 pivots on the hinge pins 190. This allows the user to push down on the thumb depression 154 to raise the other end of the clip top 152. Fabric and other materials may then be slid between the raised end of the clip top 152 and the clip bottom 156. The toe grips 174 and the receiving depressions 192 grip whatever is placed between them as the user discontinues pressure on the thumb depression 154.

When the clip assembly 150 is mounted on the holster body 108, the ribs 130 extend into the grooves 180. Simultaneously, the landing structures 160 extend to the landing surfaces 132, thus defining the mounting system and forming a co-operating, interlocking relationship between the clip assembly 150 and the holster body 108. This interlocking relationship allows the clip assembly 150 to be releasably held in a desired position relative to the holster body by the resilience of the mounting button 200.

The clip assembly 150 can be swivelled about the axis 122 by the user as indicated by the arrows in FIG. 3. The ribs 130 and the landing structures 160 can act as detents. The landing structures 160 lift over the corresponding ribs 130 and settle into the next available landing surfaces 132 when the clip assembly 150 is rotated axially. The user can adjust the orientation of the clip assembly 150 relative to the holster body 108 and it will stay in that orientation until the user desires to change it again. That is, the user has the option of adjusting the orientation of the clip assembly 150 relative to the holster body 108 by increments equal to the width or spacing of the ribs 130.

The holster 104 occasionally may receive a series of undesired or unexpected forces applied against it. Such forces often occur as the result of catching the holster 104 on an impeding item, such as a seatbelt or an armrest of a chair. Advantageously, the holster 104 can swing away from the impeding item by virtue of the of the swivel action of the clip assembly 150. In addition, when the user of the device 102 is aware of a potential for the holster 104 become snagged with an obstacle, the user has the option of rotating the holster 104, thereby to keep the device 102 and the holster 104 out of reach of the potential obstacle.

In this embodiment, the handheld device 102 is further operable to detect the magnet 124 when the magnet 124 is proximate to the handheld device 102. The magnet 124 is proximate to the handheld device 102 when the handheld device 102 is in an installed position in the holster 104. When the handheld device 102 detects that the magnet 124 is proximate to it, the handheld device 102 can respond to the detection by powering down. When the handheld device 102 is powered down, it can consume less electricity thereby extending the life of the battery or other source of power of the handheld device 102. It is within the scope of the present invention to include detection alternatives to the magnet 124.

In another, different embodiment of the invention, the handheld device 102 can detect if the magnet 124 is and is not proximate. If the handheld device 102 detects that the magnet 124 is not proximate to it, the handheld can respond to the detection by powering up and displaying visual items. The visual items can include: the contents of the latest unread message; the contents of the latest message; the list of messages in the inbox of messages, if the latest message has been read; and, the home screen, if the latest message has been read.

Preferably, the user chooses which of the above display outputs will occur and in what order. The home screen is the main screen through which access to a plurality of software applications residing on the device is available. The display output can depend on the whether the user removes the handheld device 102 from the holster 104 within a predetermined period of time from the receipt of a message after the message has arrived in the device. For example, if the user is notified of the arrival of a new message, and he removes the device 102 from the holster 104 within a short period of time thereafter, a short period being about five (5) seconds, then the display output would be the contents of the recently arrived new message.

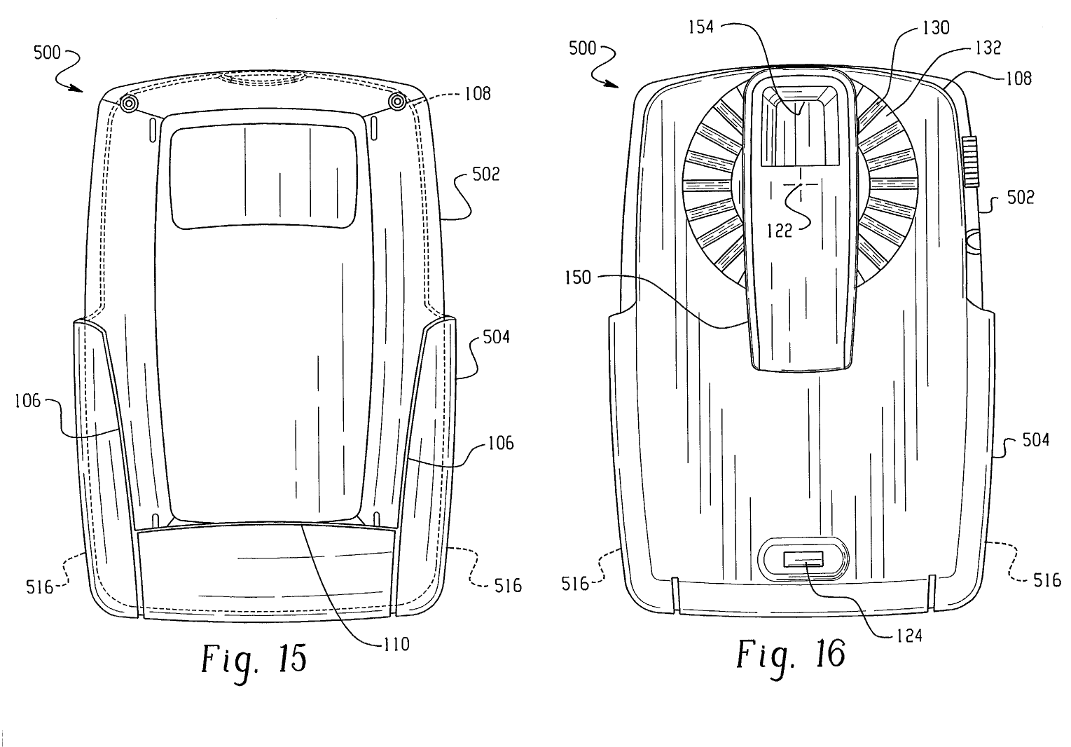

An apparatus 500 comprising a second embodiment of the invention is shown in FIG. 15. The apparatus 500 has many parts that are substantially the same as corresponding parts of the apparatus 100 described above. This is indicated by the use of the same reference numbers for such corresponding parts in FIG. 1 and FIG. 15. However, the apparatus 500 has a handheld device 502, similar to the handheld device 102, but installed in a rearward facing position in a holster 504. In this embodiment of the present invention, the screen 103 and keypad I/O are not visible because they face inward to offer protection for the screen 103 and/or the keypad 105 from impacts, scratches, dirt and debris, and the like.

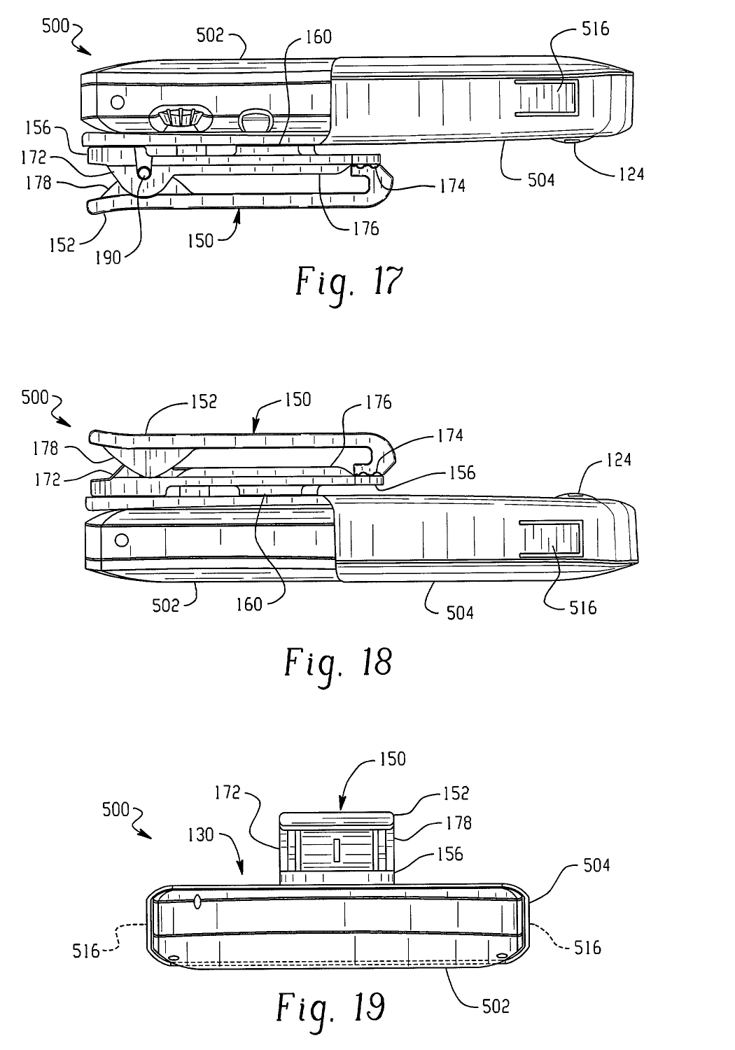

Latches 516 are located on the side wall portions 106 of the holster 504 as indicated in FIGS. 15 and 16. FIG. 16 is a rear view of the apparatus 500 shown in FIG. 15. FIG. 17 is a side view of the apparatus 500 shown in FIG. 15 and FIG. 18 is a reverse view of the apparatus shown in FIG. 17. FIG. 19 is a top view of the apparatus 500 shown in FIG. 15.

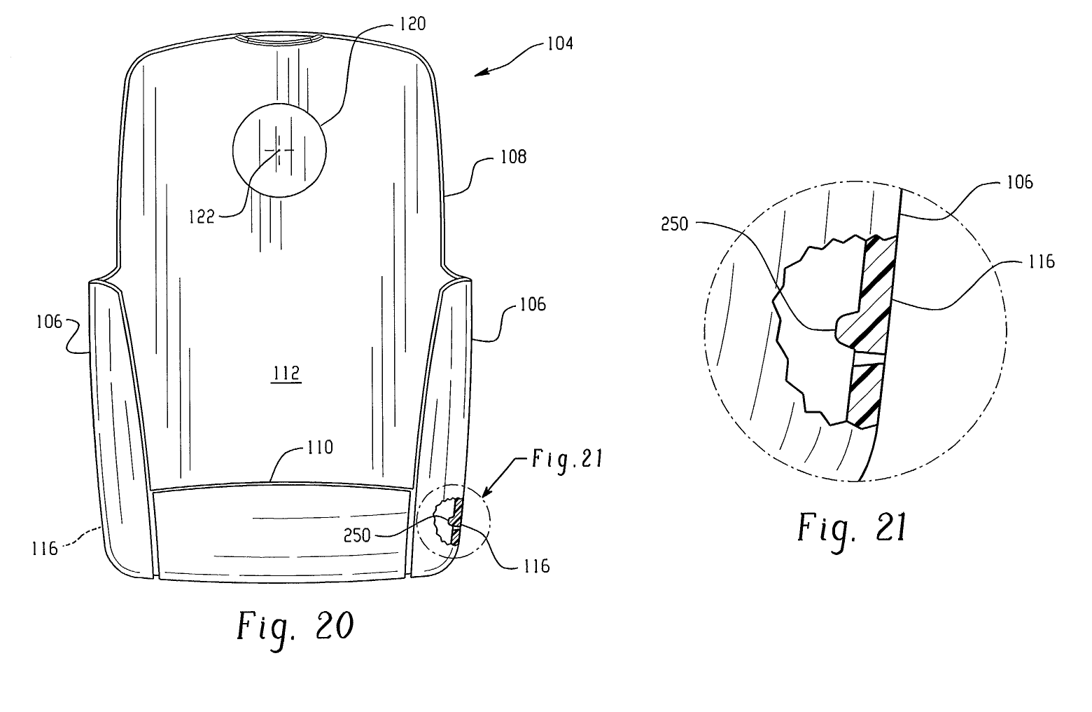

FIG. 20 depicts another aspect of the present invention. The latches 116 are located symmetrical relative to each other on the side wall portions 106 of the holster 104. At the end of the latch 116 is a flange portion 250. The latches 116 are operative to pivot outwardly in response to pressure applied to the flange portions 250. There are depressions, not shown, corresponding to the flange portions 250 in the handheld device 102.

When the handheld device 102 is installed into the pocket 112 the edge of the device 102 pushes against the flange portion 250 forcing the latch 116 to pivot outward, away from the device 102. When the device 102 is seated in the pocket 112 the corresponding depressions are aligned with the flange portions 250, which releasably snap into the depressions. Thus, the device 102 is securely held in the pocket 112 of the holster 102. To remove the device 102 from the holster 104, the user pulls the device 102 upward relative to the holster 104. The lead edge of each depression pushes against the flange 250 and forces it to pivot outward. This allows the handheld device 102 to be removed from the holster 104. The two symmetrical latches 116 hold the handheld device 102 securely in place until the user wishes to remove the handheld device 102.

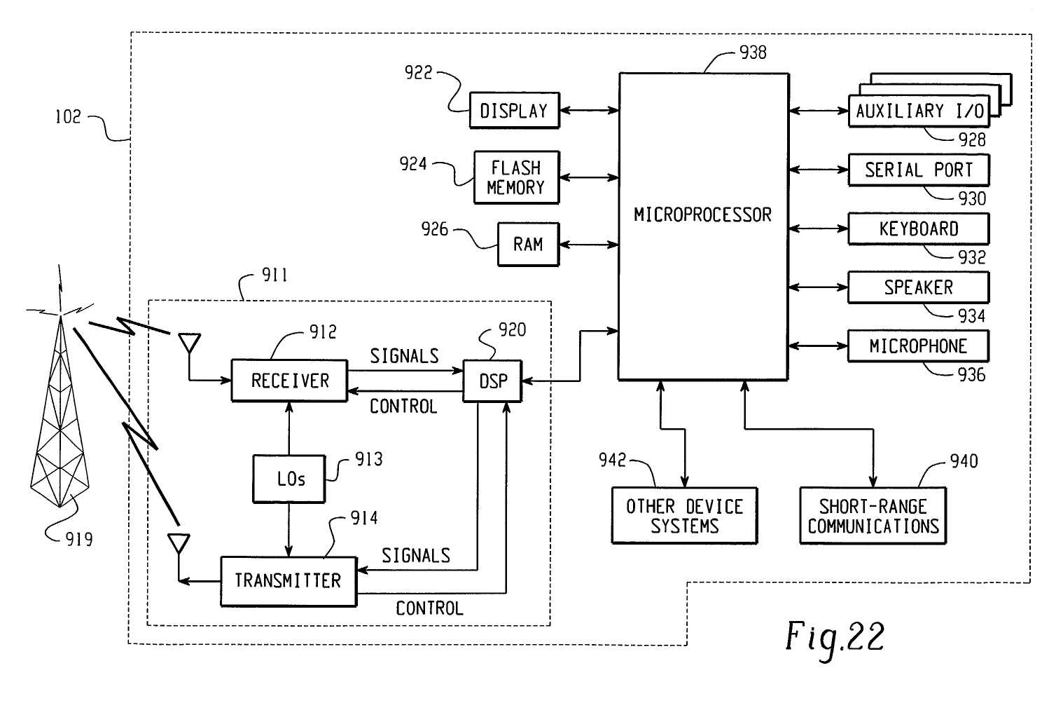

FIG. 22 is a block diagram of the handheld device 102 with which the instant invention may be used in conjunction. The handheld device 102 is preferably a two-way communication device having voice and data communication capabilities. The handheld device 102 has the capability to communicate with other computer systems on the Internet. Depending on the functionality provided by the handheld device, the handheld device may alternatively be a data messaging device, a two-way pager, a cellular telephone with data messaging capabilities, a wireless Internet appliance or a data communication device (with or without telephony capabilities).

The handheld device 102 is enabled for two-way communications and will incorporate a communication subsystem 911, including a receiver 912, a transmitter 914, and associated components such as one or more, preferably embedded or internal, antenna elements 916 and 918, local oscillators (LOs) 913, and a processing module such as a digital signal processor (DSP) 920. As will be apparent to those skilled in the field of communications, the particular design of the communication subsystem 911 will be dependent upon the communication network in which the handheld device 102 is intended to operate. For example, a handheld device destined for a North American market may include a communication subsystem 911 designed to operate within the Mobitex™ mobile communication system or DataTAC™ mobile communication system, whereas a handheld device intended for use in Europe may incorporate a General Packet Radio Service (GPRS) communication subsystem 911.

Network access requirements will also vary depending upon the type of network 919. For example, in the Mobitex and DataTAC networks, the handheld device 102 is registered on the network using a unique personal identification number or PIN associated with the handheld device 102. In GPRS networks however, network access is associated with a subscriber or user of a handheld device. A GPRS device therefore requires a subscriber identity module (not shown), commonly referred to as a SIM card, in order to operate on a GPRS network. Without a SIM card, a GPRS device will not be fully functional. Local or non-network communication functions (if any) may be operable, but the handheld device 102 will be unable to carry out any functions involving communications over network 919. When required network registration or activation procedures have been completed, the handheld device 102 may send and receive communication signals over the network 919. Signals received by the antenna 916 through a communication network 919 are input to the receiver 912, which may perform such common receiver functions as signal amplification, frequency down conversion, filtering, channel selection and analog to digital conversion. Analog to digital conversion of a received signal allows more complex communication functions such as demodulation and decoding to be performed in the DSP 920. In a similar manner, signals to be transmitted are processed, including modulation and encoding for example, by the DSP 920 and input to the transmitter 914 for digital to analog conversion, frequency up conversion, filtering, amplification and transmission over the communication network 919 via the antenna 918.

The DSP 920 not only processes communication signals, but also provides for receiver and transmitter control. For example, the gains applied to communication signals in the receiver 912 and transmitter 914 may be adaptively controlled through automatic gain control algorithms implemented in the DSP 920.

The handheld device 102 preferably includes a microprocessor 938, which controls the overall operation of the device. Communication functions, including at least data and voice communications, are performed through the communication subsystem 911. The microprocessor 938 also interacts with further device subsystems such as the display 922, flash memory 924, random access memory (RAM) 926, auxiliary input/output (I/O) subsystems 928, serial port 930, keyboard 932, speaker 934, microphone 936, a short-range communications subsystem 940 and any other device subsystems generally designated as 942.

Some subsystems perform communication-related functions, whereas other subsystems may provide “resident” or on-device functions. Notably, some subsystems, such as keyboard 932 and display 922 for example, may be used for both communication-related functions, such as entering a text message for transmission over a communication network, and device-resident functions such as a calculator or task list.

Operating system software used by the microprocessor 938 is preferably stored in a persistent store such as flash memory 924, which may instead be a read only memory (ROM) or similar storage element (not shown). Those skilled in the art will appreciate that the operating system, specific device applications, or parts thereof, may be temporarily loaded into a volatile store such as RAM 926. It is contemplated that received communication signals may also be stored to RAM 926.

The microprocessor 938, in addition to its operating system functions, preferably enables execution of software applications on the handheld device 102. A predetermined set of applications that control basic device operations, including at least data and voice communication applications for example, will normally be installed on the handheld device 102 during manufacture. A preferred application that may be loaded onto the device may be a personal information manager (PIM) application having the ability to organize and manage data items relating to the device user such as, but not limited to e-mail, calendar events, voice mails, appointments, and task items. One or more memory stores would be available on the device to facilitate storage of PIM data items on the device. Such PIM application would preferably have the ability to send and receive data items, via the wireless network. In an embodiment of the present invention, the PIM data items are seamlessly integrated, synchronized and updated, via the wireless network, with the device user's corresponding data items stored or associated with a host computer system. Further applications may also be loaded onto the handheld device 102 through the network 919, an auxiliary I/O subsystem 928, serial port 930, short-range communications subsystem 940 or any other suitable subsystem 942, and installed by a user in the RAM 926 or preferably a non-volatile store (not shown) for execution by the microprocessor 938. Such flexibility in application installation increases the functionality of the device and may provide enhanced on-device functions, communication-related functions, or both. For example, secure communication applications may enable electronic commerce functions and other such financial transactions to be performed using the handheld device 102.

In a data communication mode, a received signal such as a text message or web page download will be processed by the communication subsystem 911 and input to the microprocessor 938, which will preferably further process the received signal for output to the display 922, or alternatively to an auxiliary I/O device 928. A user of the device 102 may also compose data items such as email messages for example, using the keyboard 932, which is preferably a complete alphanumeric keyboard or telephone-type keypad, in conjunction with the display 922 and possibly an auxiliary I/O device 928. Such composed items may then be transmitted over a communication network through the communication subsystem 911.

For voice communications, overall operation of the device 102 is substantially similar, except that received signals would preferably be output to a speaker 934 and signals for transmission would be generated by a microphone 936. Alternative voice or audio I/O subsystems such as a voice message recording subsystem may also be implemented on the device 102. Although voice or audio signal output is preferably accomplished primarily through the speaker 934, the display 922 may also be used to provide an indication of the identity of a calling party, the duration of a voice call, or other voice call related information, for example.

The serial port 930 in FIG. 22 would normally be implemented in a personal digital assistant (PDA)-type communication device for which synchronization with a user's desktop computer (not shown) may be desirable, but is an optional device component. Such a port 930 would enable a user to set preferences through an external device or software application and would extend the capabilities of the device by providing for information or software downloads to the device 102 other than through a wireless communication network. The alternate download path may for example be used to load an encryption key onto the device through a direct and thus reliable and trusted connection to thereby enable secure device communication.

A short-range communications subsystem 940 is a further optional component which may provide for communication between the device 924 and different systems or devices, which need not necessarily be similar devices. For example, the subsystem 940 may include 15 an infrared device and associated circuits and components or a Bluetooth™ communication module to provide for short-range communication with similarly-enabled systems and devices.

It will be appreciated that the above description relates to the preferred embodiments by way of example only. Many variations on the invention will be obvious to those knowledgeable in the field, and such variations are within the scope of the invention as described and claimed.

1. An apparatus for use with a handheld device, comprising:
a) a holster configured to receive and releasably retain the handheld device;
b) a clip assembly; and
c) a mounting structure centered on an axis and configured to secure the clip assembly to the holster, the mounting structure having a hub supporting the clip assembly for rotation relative to the holster about the axis.

2. An apparatus as defined in claim 1, wherein the mounting structure further has a detent structure defining an array of selectable positions spaced circumferentially about the axis.

3. An apparatus as defined in claim 1, wherein the handheld device is a cellular phone, mobile handheld, digital wireless phone, 1-way pager, 1½-way pager, 2-way pager, electronic mail appliance, internet appliance, personal digital assistant (PDA), laptop computer, or portable digital audio player.

4. An apparatus as defined in claim 1, wherein the handheld device is operable to detect a proximate magnet and to power down in response to the detection of the proximate magnet, and the apparatus further comprising a magnet such that when the handheld device is holstered, the magnet is proximate to the handheld device, thereby to power down the holstered handheld device.

5. An apparatus as defined in claim 1, wherein the handheld device faces into the holster when holstered, thereby to protect a display screen on the front of the handheld device.

6. An apparatus as defined in claim 1, wherein the handheld device faces outward when holstered, thereby to allow messages to be visible on a display screen on the front of the handheld device.

7. An apparatus as defined in claim 6, wherein the messages are selected from the group consisting of advertisements, logos, slogans, stock reports, weather updates, sports scores, brand names, and trademarks.

8. An apparatus as defined in claim 1, further comprising at least two fasteners, each located on one side of the holster and operative to engage and releasably retain the handheld device.

9. An apparatus, comprising:
a) a handheld device; and
b) a holster configured to receive and releasably retain the handheld device;
the handheld device and the holster together defining interlocking tabs and slots configured to co-operate to releasably retain the handheld device in the holster.

10. An apparatus as defined in claim 9, where the holster has the tabs and the handheld device has the slots.

11. An apparatus as defined in claim 9, wherein the handheld device is a cellular phone, mobile handheld, digital wireless phone, 1-way pager, 1½-way pager, 2-way pager, electronic mail appliance, internet appliance, personal digital assistant (PDA), laptop computer, or portable digital audio player.

12. An apparatus as defined in claim 9, wherein the handheld device is operable to detect a proximate magnet and to power down in response to the detection of the proximate magnet, and the apparatus further comprising a magnet such that when the handheld device is holstered, the magnet is proximate to the handheld device, thereby to power down the holstered handheld device.

13. An apparatus as defined in claim 9, wherein the handheld device faces into the holster when holstered thereby to protect a display screen on the handheld device.

14. An apparatus as defined in claim 9, wherein the handheld device faces outward when holstered thereby to allow messages to be visible on a display screen on the handheld device.

15. An apparatus as defined in claim 14, wherein the messages are selected from the group consisting of advertisements, logos, slogans, stock reports, weather updates, sports scores, brand names, and trademarks.

16. An apparatus as defined in claim 9, wherein there are two tabs and two slots.

17. A method of adjusting a handheld device holster, comprising the steps of:
providing a holster having a rotatable clip assembly, where the holster is for use with a handheld device;
placing the handheld device in the holster; and
rotating the clip assembly relative to the holster to a desired position, thereby to adjust the handheld device holster.

18. The method as defined in claim 17, further comprising the step of securing the handheld device in the holster with at least two symmetrical latches.

19. An apparatus for use with a handheld device, comprising:
a) means for receiving and releasably retaining the handheld device;
b) means for clipping; and
c) means for securing the means for clipping to the means for retaining the handheld device, the means for securing operative to define an array of selectable positions spaced circumferentially about the axis.

20. An apparatus for use with a handheld device, comprising:
a) a holster configured to receive and releasably retain the handheld device;
b) a clip assembly;
c) a mounting structure centered on an axis and configured to secure the clip assembly to the holster, the mounting structure having a hub supporting the clip assembly for rotation relative to the holster about the axis and,
the handheld device is operable to detect removal of the handheld device from the holster and responsive to the removal of the handheld device from the holster by displaying output onto a display screen on the handheld device and the output is dependent on the state of one or more messages stored on the handheld device.

21. An apparatus as defined in claim 20, wherein the state of one or more messages includes an unread message.

22. An apparatus as defined in claim 21, wherein the output is the contents of the unread message.
